(19) United States
(12) Patent Application Publication
(10) Pub. No.: US 2026/0017956 A1
(43) Pub. Date: Jan. 15, 2026

(54) RETRIEVAL METHOD FOR OPEN-VOCABULARY 3D TARGET, DEVICE AND STORAGE MEDIUM

(71) Applicant: Beijing Zitiao Network Technology Co., Ltd., Beijing (CN)

(72) Inventors: Zhishan ZHOU, Beijing (CN); Yunke CAI, Beijing (CN); Chunjie WANG, Beijing (CN); Xiaosheng YAN, Beijing (CN); Min DU, Beijing (CN); Xiao LIU, Beijing (CN)

(21) Appl. No.: 19/265,517

(22) Filed: Jul. 10, 2025

(30) Foreign Application Priority Data
Jul. 10, 2024 (CN) 202410925817.3

(51) Int. Cl. G06V 20/64; G06F 16/58; G06F 40/40; G06T 7/11; G06T 7/246; G06T 7/73; G06V 10/26; G06V 10/30; G06V 10/98

(52) U.S. Cl. CPC G06V 20/64; G06F 16/5866; G06F 40/40; G06T 7/11; G06T 7/246; G06T 7/73; G06V 10/267; G06V 10/30; G06V 10/993; G06T 2207/10016; G06T 2207/10028; G06T 2207/30168

(57) ABSTRACT

A retrieval method for an open-vocabulary 3D target, a device and a storage medium are provided. The method includes: inputting text description information of a target object and an image sequence of a real scene into an open-vocabulary 3D target retrieval model. The retrieval model includes an LLM, an open-vocabulary 2D detection and segmentation model, an object filtering module and a 3D projection module. The LLM is used to enhance the text description information to obtain names of a plurality of candidate objects of the target object. The open-vocabulary 2D detection and segmentation model is used to detect and segment according to the names of the candidate objects, to obtain 2D segmentation masks of the plurality of candidate objects. The object filtering module is used to determine the target object from the candidate objects according to the text description information and a 2D segmentation mask of each candidate object.

### CROSS-REFERENCE TO RELATED APPLICATION

The present application claims priority of the Chinese Patent Application No. 202410925817.3, filed on Jul. 10, 2024, the disclosure of which is incorporated herein by reference in its entirety as part of the present application.

### TECHNICAL FIELD

Embodiments of the present disclosure relates to a field of image processing technology, especially to a retrieval method for an open-vocabulary 3D target, an apparatus, a device and a storage medium.

### BACKGROUND

Open-vocabulary three-dimensional (3D) target perception refers to perception tasks of segmenting/detecting objects of any open categories/features in a 3D scene that are not defined in advance. By inputting the 3D scene and a text description of a target to be retrieved, an open-vocabulary 3D target retrieval model identifies a target object corresponding to the text description and outputs a 3D position of the target object in the 3D scene.

The existing open-vocabulary 3D target retrieval models are usually used for retrieval and localization of 2D objects. In response to the existing open-vocabulary 3D target retrieval models being directly applied to the 3D scene, the accuracy of retrieval results of 3D objects is low.

### SUMMARY

The embodiments of the present disclosure provide a retrieval method for an open-vocabulary 3D target, an apparatus, a device and a storage medium, and the accuracy of retrieval results of open-vocabulary 3D objects is improved.

The embodiments of the present disclosure provide a retrieval method for an open-vocabulary 3D target, which includes:
acquiring text description information of a target object and an image sequence of a real scene; and
inputting the text description information and the image sequence into an open-vocabulary 3D target retrieval model to obtain a retrieval result of the target object, where the open-vocabulary 3D target retrieval model includes a large language model (LLM), an open-vocabulary two-dimensional (2D) detection and segmentation model, an object filtering module and a 3D projection module.

The LLM is used to enhance the text description information to obtain names of a plurality of candidate objects of the target object.

The open-vocabulary 2D detection and segmentation model is used to detect and segment the plurality of candidate objects by using the names of the plurality of candidate objects and the image sequence as inputs, to obtain 2D segmentation masks of the plurality of candidate objects.

The object filtering module is used to determine the target object from the plurality of candidate objects according to the text description information and a 2D segmentation mask of each candidate object.

The 3D projection module is used to project a 2D segmentation mask of the target object into a 3D scene according to image depth information, and correct a projection result to obtain a position of the target object in the 3D scene.

In some exemplary embodiments, the open-vocabulary 3D target retrieval model further includes a tracking processing module and an image screening module, and a detection result of the open-vocabulary 2D detection and segmentation model further includes 2D detection boxes of the plurality of candidate objects.

The tracking processing module is used to, according to temporal information of the 2D detection boxes of the plurality of candidate objects, perform tracking processing on the plurality of candidate objects to form a tracking image sequence corresponding to each candidate object.

The image screening module is used to screen the tracking image sequences corresponding to the plurality of candidate objects according to image quality, to obtain a target image sequence corresponding to each candidate object, a 2D segmentation mask of a target image in the target image sequence corresponding to the candidate object forms the 2D segmentation mask of the candidate object.

The object filtering module is used to determine the target object from the plurality of candidate objects according to the text description information and the 2D segmentation mask of the target image in the target image sequence corresponding to each candidate object.

In some exemplary embodiments, the tracking processing module uses a ByteTrack algorithm to aggregate the 2D detection boxes of the plurality of candidate objects to form a tracking image sequence corresponding to each candidate object.

In some exemplary embodiments, the image screening module is used to: for the tracking image sequence corresponding to each candidate object, screen the tracking image sequence corresponding to the candidate object according to a quality parameter of the candidate object, to obtain the target image sequence corresponding to the candidate object, where the quality parameter includes at least one of the group consisting of: a position of the candidate object in a tracking image, a proportion of an area of the candidate object in the tracking image, or a camera angle corresponding to the candidate object.

In some exemplary embodiments, the object filtering module is used to:
generate a prompt of a multi-modal large language model according to the text description information;
determine the prompt and the 2D segmentation mask of the target image in the target image sequence corresponding to each candidate object as inputs of the multi-modal large language model.

The multi-modal large language model is used to identify whether the 2D segmentation mask of the target image is the target object according to the text description information and the 2D segmentation mask of the target image in the target image sequence corresponding to each candidate object, determine a truth proportion of each candidate object according to an identification result, determine whether the candidate object is the target object according to the truth proportion of each candidate object, and output a determination result, where the truth proportion is a ratio of a quantity of images of which the identification results of the candidate objects are true to a total quantity of images in the target image sequence corresponding to the candidate objects; and according to the identification results of the multiple candidate objects, determine the target object from the plurality of candidate objects.

In some exemplary embodiments, the object filtering module is used to:
use the text description information and the 2D segmentation mask of the target image in the target image sequence corresponding to each candidate object as inputs of a visual language model.

The visual language model is used to identify whether the 2D segmentation mask of the target image is the target object according to the text description information and the 2D segmentation mask of the target image in the target image sequence corresponding to each candidate object; and determine the target object from the plurality of candidate objects according to an identification result of each candidate object.

In some exemplary embodiments, the 3D projection module is used to:
when the 2D segmentation mask of the target object includes 2D segmentation masks of a multi-frame target images, merge and project the 2D segmentation masks of the multi-frame target images into the 3D scene according to depth information of the multi-frame target images, to obtain a first 3D segmentation mask of the target object;
perform point cloud expansion on a sparse point cloud of the first 3D segmentation mask, to obtain a complete and dense second 3D segmentation mask;
re-project the second 3D segmentation mask into each frame of the target image, to obtain a first 2D segmentation mask of the target object in each frame of the target image;
for each frame of the target image, according to a position of the 2D segmentation mask of the target image, filter out a projection point outside the 2D segmentation mask of the target image from the first 2D segmentation mask, to obtain a second 2D segmentation mask of the target object;
merge and project the second 2D segmentation masks in the multi-frame target images into the 3D scene to obtain a third 3D segmentation mask according to the depth information of the multi-frame target images; and
determine the position of the target object in the 3D scene according to the third 3D segmentation mask.

In some exemplary embodiments, the determining the position of the target object in the 3D scene according to the third 3D segmentation mask, includes:
filtering out noise points in the third 3D segmentation mask to obtain a fourth 3D segmentation mask; and
determining the position of the target object in the 3D scene according to the fourth 3D segmentation mask.

In some exemplary embodiments, the filtering out noise points in the third 3D segmentation mask to obtain a fourth 3D segmentation mask, includes:
determining a connected region according to points in the third 3D segmentation mask, and filtering out isolated noise points in the third 3D segmentation mask according to a size of the connected region to obtain the fourth 3D segmentation mask.

In some exemplary embodiments, the enhancing the text description information to obtain names of a plurality of candidate objects of the target object, includes:
generating a prompt of the LLM according to the text description information; and
inputting the prompt into the LLM, to obtain the names of the plurality of candidate objects of the target object, where the LLM is used to extract a subject name from the text description information, perform synonym and/or near-synonym extension on the extracted subject name to obtain one or more extension names, and determine the subject name and the extension names as the names of the candidate objects of the target object.

In some exemplary embodiments, the open-vocabulary 2D detection and segmentation model uses a grounding-SAM model.

The embodiments of the present disclosure provide a retrieval apparatus for an open-vocabulary 3D target, which includes an acquisition module and a retrieval module.

The acquisition module is configured to acquire text description information of a target object and an image sequence of a real scene.

The retrieval module is configured to input the text description information and the image sequence into an open-vocabulary dimensional (3D) target retrieval model, to obtain a retrieval result of the target object. The open-vocabulary 3D target retrieval model includes a large language model (LLM), an open-vocabulary two-dimensional (2D) detection and segmentation model, an object filtering module and a 3D projection module.

The LLM is used to enhance the text description information, to obtain names of a plurality of candidate objects of the target object.

The open-vocabulary 2D detection and segmentation model is used to detect and segment the plurality of candidate objects by using the names of the plurality of candidate objects and the image sequence as inputs, to obtain 2D segmentation masks of the plurality of candidate objects.

The object filtering module is used to determine the target object from the plurality of candidate objects according to the text description information and a 2D segmentation mask of each candidate object.

The 3D projection module is used to project a 2D segmentation mask of the target object into a 3D scene according to image depth information, and correct a projection result to obtain a position of the target object in the 3D scene.

The embodiments of the present disclosure provide an electronic device, which includes a processor and a memory. The memory is used to store a computer program, and the processor is used to invoke and run the computer program stored in the memory, to execute the method mentioned above.

The embodiments of the present disclosure provide a computer-readable storage medium. The computer-readable storage medium is configured to store a computer program, and the computer program causes a computer to execute the method mentioned above.

The embodiments of the present disclosure provide a computer program product, which includes a computer program. When the computer program is executed by a processor, the processor is caused to implement the method mentioned above.

### BRIEF DESCRIPTION OF DRAWINGS

In order to describe the technical solutions in the embodiments of the present disclosure more clearly, the accompanying drawings for describing the embodiments are briefly described below. Apparently, the accompanying drawings in the following description are merely some embodiments of the present disclosure, and those skilled in the art may derive other accompanying drawings from these accompanying drawings without creative efforts.

FIG. 1 is a flow diagram of a retrieval method for an open-vocabulary 3D target provided in an embodiment of the present disclosure;

FIG. 2 is a schematic diagram of the input and output of an LLM;

FIG. 3 is a schematic diagram of segmentation of a Grounding-SAM;

FIG. 4 is a flow diagram of a retrieval method for an open-vocabulary 3D target provided in an embodiment of the present disclosure;

FIG. 5 is a schematic diagram of a processing process of an open-vocabulary 3D target retrieval model;

FIG. 6 is a schematic diagram of processing results of a tracking processing module and an image screening module;

FIG. 7 is a schematic diagram of the input and output of a multi-modal large language model;

FIG. 8 is a schematic diagram of data changes during the projection and correction process of a 3D projection module;

FIG. 9 is a structural schematic diagram of a retrieval apparatus for an open-vocabulary 3D target provided in an embodiment of the present disclosure; and

FIG. 10 is a structural schematic diagram of an electronic device provided in an embodiment of the present disclosure.

### DETAILED DESCRIPTION

The following will be combined with the drawings in the embodiments of the present disclosure, and the technical solutions in the embodiments of the present disclosure are clearly and completely described. Obviously, the embodiments described are only part of the embodiments of the present disclosure, and not all embodiments. Based on the embodiments of the present disclosure, all other embodiments obtained by a person skilled in the art without making creative work belong to the scope of protection of the present disclosure.

It should be noted that the terms “first”, “second” etc. in the description and claims of the present disclosure and the above-mentioned drawings are used to distinguish similar objects, and do not have to be used to describe a specific order or sequence. It should be understood that the used data are interchangeable in appropriate cases so that the embodiments of the present disclosure described here can be implemented in an order other than those illustrated or described here. In addition, the terms “including” and “having” and any variation thereof are intended to cover non-exclusive inclusions, e.g., a process, method, system, product or service that include a series of steps or elements need not be limited to those steps or elements that are clearly listed, but may include other steps or elements that are not clearly listed or are inherent to those processes, methods, products or equipment.

In order to facilitate the understanding of the embodiments of the present disclosure, before describing each embodiment of the present disclosure, firstly, the embodiments of the present application of the present disclosure involved in some of the concepts are appropriately elaborated.

Open-vocabulary, also known as opened vocabulary, is a concept relative to closed vocabulary. In computer vision tasks, the open-vocabulary refers to an extensible label set, and allows a system to self-update and learn new labels when the system encounters new objects or scenes, and to adapt to the diversity of the real world better, but the closed vocabulary has a fixed label set.

Most of traditional tasks such as target segmentation, detection, and tracking are based on closed sets, which means that models (such as a deep neural network model) may only identify pre-defined categories existing in training sets. Models based on the open-vocabulary may identify and locate new categories of objects in the image that do not appear in the training sets, which has the important application value for fields such as robotics, autonomous driving, and mix reality (MR).

Open-vocabulary 3D target retrieval is also known as open-vocabulary 3D object instance retrieval. By inputting a 3D scene and any text description of an instance to be retrieved, an open-vocabulary 3D target retrieval model outputs a 3D position of the object instance corresponding to the text description.

The embodiments of the present disclosure provide a retrieval method for an open-vocabulary 3D target, an apparatus, a device and a storage medium. The method includes: acquiring text description information of a target object and an image sequence of a real scene; and inputting the text description information and the image sequence into an open-vocabulary 3D target retrieval model to obtain a retrieval result of the target object. The open-vocabulary 3D target retrieval model includes an LLM, an open-vocabulary 2D detection and segmentation model, an object filtering module and a 3D projection module. The LLM is used to enhance the text description information to obtain names of a plurality of candidate objects of the target object. The open-vocabulary 2D detection and segmentation model is used to detect and segment the plurality of candidate objects by using the names of the plurality of candidate objects and the image sequence as inputs, to obtain 2D segmentation masks of the plurality of candidate objects. The object filtering module is used to determine the target object from the plurality of candidate objects according to the text description information and the 2D segmentation mask of each candidate object. The 3D projection module is used to project a 2D segmentation mask of the target object into a 3D scene according to image depth information, and correct a projection result to obtain a position of the target object in the 3D scene. The method uses a plurality of pre-trained multi-modal models to improve the accuracy of retrieval results of the open-vocabulary 3D objects.

The method of the embodiments of the present disclosure may be implemented by a terminal device or a server. The terminal device may be an extended reality (XR) device, various types of robots, an intelligent driving vehicle, an unmanned air vehicle, a mobile phone, a tablet computer, a desktop computer, a portable notebook computer and the like. The XR device may be a virtual reality (VR) device, an augmented reality (AR) device, or an MR device. The server is used to retrieve open-vocabulary 3D targets, and for example, the server is a control device for an unmanned driving vehicle.

After application scenarios of the embodiments of the present disclosure are introduced, a retrieval method for an open-vocabulary 3D target provided in an embodiment of the present disclosure is described in detail below in combination with drawings.

FIG. 1 is a flow diagram of a retrieval method for an open-vocabulary 3D target provided in an embodiment of the present disclosure. The execution body of the embodiment is a terminal device or a server. The terminal device is taken as an example below, and as shown in FIG. 1, the method of the embodiment includes the following steps.
S101: acquiring text description information of a target object and an image sequence of a real scene.

The terminal device provides an input page for a retrieval target. A user inputs the text description information of a 3D target to be retrieved on the input page. The text description information may include a name, function description information, shape information, a size and the like of the 3D target to be retrieved, and the text description information of the 3D target is not limited in the embodiment.

The image sequence of a real scene includes a multi-frame images. The image sequence may be a video of the real scene (or referred to as the real world or physical scene) captured by a camera of the terminal device, or a video of the real scene captured by cameras of other devices. The other devices send the captured video of the real scene to the terminal device, and the retrieval for the 3D target is performed by the terminal device.
S102: inputting the text description information and the image sequence into an open-vocabulary 3D target retrieval model, to obtain a retrieval result of the target object, where the open-vocabulary 3D target retrieval model includes an LLM, an open-vocabulary 2D detection and segmentation model, an object filtering module and a 3D projection module.

The LLM is used to enhance the text description information, to obtain names of a plurality of candidate objects of the target object.

The open-vocabulary 2D detection and segmentation model is used to detect and segment the plurality of candidate objects by using the names of the plurality of candidate objects and the image sequence as inputs, to obtain 2D segmentation masks of the plurality of candidate objects.

The object filtering module is used to determine the target object from the plurality of candidate objects according to the text description information and a 2D segmentation mask of each candidate object.

The 3D projection module is used to project a 2D segmentation mask of the target object into a 3D scene according to image depth information, and correct a projection result to obtain a position of the target object in the 3D scene.

The open-vocabulary 3D target retrieval model is based on a pipeline (PPL) of a pre-trained model to implement the retrieval for the 3D target, both the LLM and the open-vocabulary 2D detection and segmentation model may use the pre-trained model, and optionally, the object filtering module may also use the pre-trained model.

The LLM refers to natural language processing models that have a large number of parameters. These models are typically based on a deep learning technology, especially a Transformer architecture, and understand and generate a human language by training on a large-scale corpus.

The large language model has a strong context understanding ability, which enables the large language model to better understand the context of a text and generate responses that are more in line with the context. The large language model also has a generative ability, the large language model may not only understand and analyze the text, but also generate the natural and fluent language, and the large language model may be applied to various generative tasks. In the embodiment, the LLM may generate the names of the plurality of candidate objects of the target object according to the text description information of the target object.

The input of the LLM is a prompt, and the prompt is a natural language input and is used to indicate what actions the model should take or what outputs the model should generate when the model performs the task. Therefore, the prompt may also be understood as a command or instruction. A good prompt may help the model understand the user's needs more accurately, thereby more useful answers are given.

The prompt includes the following parts: an instruction part, input data, and an output indicator. The instruction part is used to describe specific instructions or tasks that are specified by the user and are required to be completed by the model, and the instruction part usually uses a natural language form to describe the task or instruction. The input part may be some specific questions or contents, and the input part may vary according to usage scenarios. The output indicator part is used to describe a requirement for an output result of the large language model, and the requirement may be a requirement for the content and form of the output result.

Exemplarily, the terminal device generates a prompt of the LLM according to the text description information, and the prompt is input to the LLM to obtain the names of the plurality of candidate objects of the target object. The LLM is used to extract a subject name from the text description information, perform synonym and/or near-synonym extension on the extracted subject name to obtain one or more extension names, and determine the subject name and the extension names as the names of the candidate objects of the target object.

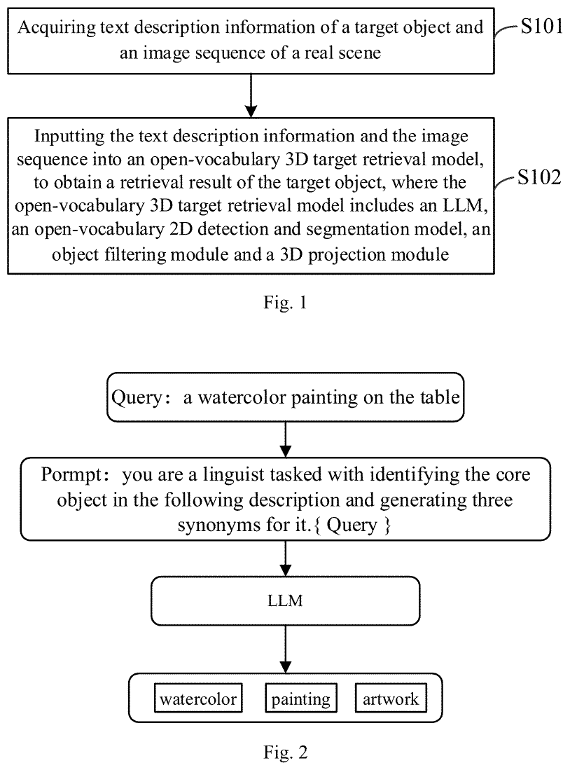

FIG. 2 is a schematic diagram of the input and output of an LLM. Referring to FIG. 2, it is assumed that the text description information (Query) of the target object is a watercolor painting on the table, the prompt of the LLM may be following.

Prompt: you are a linguist tasked with identifying the core object in the following description and generating three synonyms for it. {Query} in the prompt is the text description information of the target object.

The LLM generates names of three candidate object for the target object according to the prompt. The names are: watercolor, painting, and artwork. The watercolor is the subject name of the target object, and the painting and artwork are a result obtained by synonym extension.

The output result of the LLM in FIG. 2 includes the names of three candidate objects of the target object. It may be understood that the output result of the LLM may also include the names of the more candidate objects. The embodiment of the present disclosure does not limit the quantity of the candidate objects, but the output result should include the names of at least two candidate objects.

Optionally, the LLM may use a Generative Pre-trained Transformer (GPT) model, such as GTP4.

At present, the recall rate of the open-vocabulary 3D target retrieval is relatively low in real scenarios. In the present embodiment, the LLM is used to enhance the text description information of the target object, so as to improve the recall effect of a downstream multi-modal perception model, thereby the recall rate of the overall PPL in the retrieval task is improved.

The open-vocabulary 2D detection and segmentation model performs 2D segmentation and detection on the images in the image sequence based on the names of all candidate objects output by the LLM, to obtain a 2D segmentation mask of each candidate object.

The segmentation mask is a technology in computer vision, which is used to accurately separate an object in the image from the background. The segmentation mask implements fine-grained division of an image region by classifying and labeling each pixel. Each pixel point is assigned with a label to indicate whether the pixel point belongs to the foreground or background, or to a different object category, and the label information forms a two-dimensional matrix, i.e., a segmentation mask.

The open-vocabulary 2D detection and segmentation model is a multi-modal model that includes a text modal and an image modal. The accuracy of detection results may be improved by using a multi-modal detection and segmentation model.

Exemplarily, the open-vocabulary 2D detection and segmentation model uses a Grounding Segment Anything Model (Grounding-SAM). The Grounding-SAM may automatically detect the object in the image through the text prompt and generate an accurate segmentation mask. The Grounding-SAM has excellent generalization performance, and may effectively segment almost any visible objects in various complex scenes.

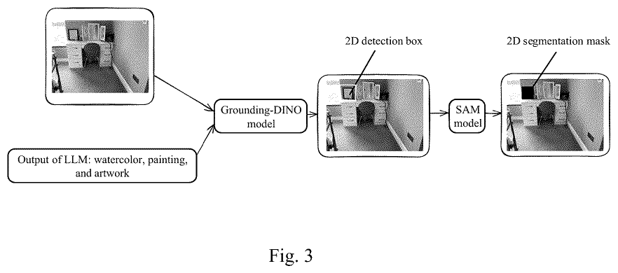

FIG. 3 is a schematic diagram of segmentation of a Grounding-SAM. As shown in FIG. 3, the Grounding-SAM includes a Grounding-DINO model and a Segment Anything Model (SAM). The Grounding-DINO model is used to perform 2D detection on the candidate object in the image according to the name of the candidate object, to obtain a 2D detection box of the candidate object. The SAM is used to identify and segment the object in the 2D detection box, to obtain a 2D segmentation mask of the candidate object.

The object filtering module is used to determine the target object from the plurality of candidate objects according to the text description information and the 2D segmentation mask of each candidate object.

In order to improve the recall rate, a preliminary detection result of the open-vocabulary 2D detection and segmentation model includes as many objects as possible, where the preliminary detection result includes objects that do not meet the text description information. For example, the preliminary detection result of the example shown in FIG. 2 includes an erroneous object “painting on the wall”. In the embodiment, the preliminary detection result is filtered by the object filtering module, so as to filter out the objects that do not meet the text description information, and to eliminate an erroneous detection result from the upstream multi-modal open-vocabulary 2D detection and segmentation model, thereby the accuracy of a final result is improved.

Optionally, the object filtering module uses a Vision-Language Model (VLM) or an improved model of the VLM to filter the preliminary detection result. The VLM is a multi-modal model that may learn from both the image and text simultaneously. The VLM uses the deep learning technology to combine image and text information to construct a model that may understand and generate the association between the image and the text.

The VLM may be used in scenes such as image identification and visual question-answer. The VLM may also be a generative model that may generate a text as an output according to image and text inputs.

The 3D projection module is used to project the 2D segmentation mask of the target object into a 3D scene according to image depth information, and correct a projection result to obtain a position of the target object in the 3D scene.

The result after being processed by the LLM, the open-vocabulary 2D detection and segmentation model, and the object filtering module is a 2D detection result. At this moment, the 2D detection result is required to be converted into a 3D detection result. In the embodiment, the 3D projection module is used to project the 2D segmentation mask of the target object into the 3D scene. The 3D projection module is used to project the 2D segmentation mask of the target object into the 3D scene according to the image depth information, and correct the projection result to obtain the position of the target object in the 3D scene.

Optionally, in some implementation modes, the 3D projection module projects the 2D segmentation mask of the target object into the 3D scene (i.e., a real scene) according to the image depth information, or directly uses the projection result (i.e., the 3D segmentation mask of the target object in the 3D scene) as the position of the target object in the 3D scene.

When the 3D projection module performs the projection, the 3D projection module also requires image depth information. Correspondingly, when the terminal device acquires the image sequence of the real scene, the terminal device also needs to acquire the depth information of each frame of the image. During the projection, the terminal device performs the projection according to the target image in which the 2D segmentation mask of the target object is located and the depth information corresponding to the target image.

The 3D projection module improves the accuracy of the retrieval result of the open-vocabulary 3D target by correcting the projection result.

The final retrieval result output by the open-vocabulary 3D target retrieval model includes the position of the target object in the 3D scene, and optionally, the final retrieval result may also include the type or name or the like of the target object.

In the embodiment, the text description information of the target object and the image sequence of the real scene are acquired, and the text description information and the image sequence are input into the open-vocabulary 3D target retrieval model to obtain the retrieval result of the target object. The open-vocabulary 3D target retrieval model includes an LLM, an open-vocabulary 2D detection and segmentation model, an object filtering module and a 3D projection module. The LLM is used to enhance the text description information to obtain names of plurality of candidate objects of the target object. The open-vocabulary 2D detection and segmentation model is used to detect and segment the plurality of candidate objects by using the names of the plurality of candidate objects and the image sequence as inputs, to obtain 2D segmentation masks of the plurality of candidate objects. The object filtering module is used to determine the target object from the plurality of candidate objects according to the text description information and the 2D segmentation mask of each candidate object. The 3D projection module is used to project the 2D segmentation mask of the target object into a 3D scene according to image depth information, and correct a projection result to obtain the position of the target object in the 3D scene. The method improve the accuracy of the retrieval result by using a plurality of pre-trained multi-modal models to retrieve the open-vocabulary 3D target.

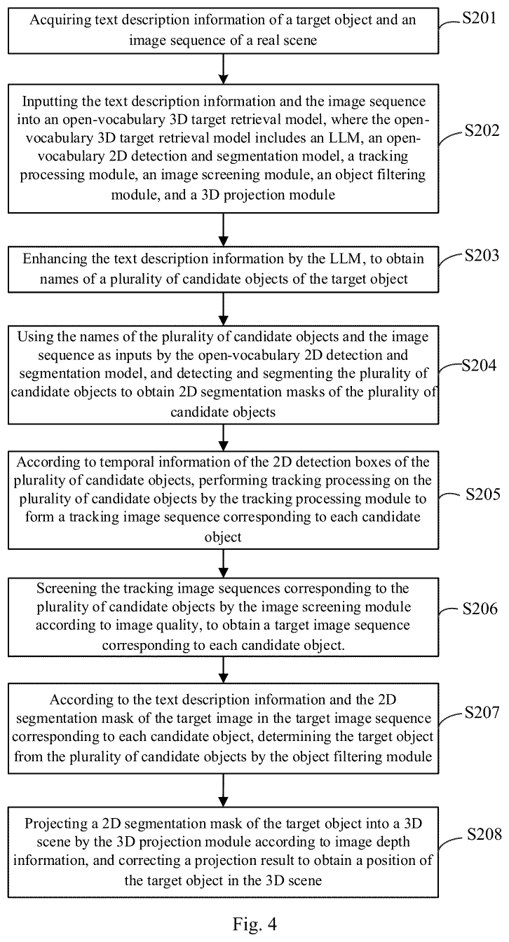

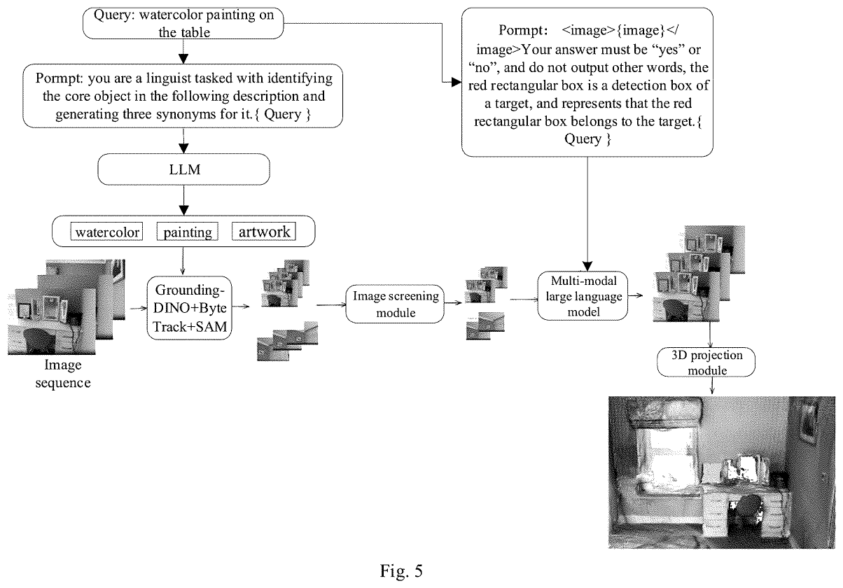

An embodiment of the present disclosure provides a retrieval method for an open-vocabulary 3D target. In the embodiment, on the basis of the above embodiment, the open-vocabulary 3D target retrieval model further includes a tracking processing module and an image screening module. FIG. 4 is a flow diagram of a retrieval method for an open-vocabulary 3D target provided in an embodiment of the present disclosure, and FIG. 5 is a schematic diagram of a processing process of an open-vocabulary 3D target retrieval model. Referring to FIGS. 4 and 5, the method provided in the present embodiment includes the following steps.
S201: acquiring text description information of a target object and an image sequence of a real scene.
S202: inputting the text description information and the image sequence into an open-vocabulary 3D target retrieval model, where the open-vocabulary 3D target retrieval model includes an LLM, an open-vocabulary 2D detection and segmentation model, a tracking processing module, an image screening module, an object filtering module, and a 3D projection module.
S203: enhancing the text description information by the LLM, to obtain names of a plurality of candidate objects of the target object.
S204: using the names of the plurality of candidate objects and the image sequence as inputs by the open-vocabulary 2D detection and segmentation model, and detecting and segmenting the plurality of candidate objects to obtain 2D segmentation masks of the plurality of candidate objects.

Specific implementation modes of the steps S201-S204 refer to the relevant description of the above embodiment, and it is not repeatedly described here.
S205: according to temporal information of the 2D detection boxes of the plurality of candidate objects, performing tracking processing on the plurality of candidate objects by the tracking processing module to form a tracking image sequence corresponding to each candidate object.

Correspondingly, the detection result of the open-vocabulary 2D detection and segmentation model not only includes the 2D segmentation masks of the plurality of candidate objects, but also the 2D detection boxes of the plurality of candidate objects. The 2D detection box is used to identify the boundary of an object.

In the detection result of the open-vocabulary 2D detection and segmentation model, the 2D detection box of each candidate object is a time sequence discrete or discontinuous 2D detection box. For example, for a candidate object 1, the 2D detection box is only detected in frames 1, 5 and 8, and for a candidate object 2, the 2D detection box is only detected in frames 1, 4 and 6. It may be inferred that the 2D detection boxes of the candidate object 1 and the candidate object 2 are discontinuous in time sequence, i.e., discrete.

The tracking processing module may use a Multi Object Tracking (MOT) method to perform tracking processing on the 2D detection boxes of the plurality of candidate objects, to obtain the tracking image sequence corresponding to each candidate object, and the images in the tracking image sequence are continuous images in time sequence.

The main concept of the MOT is to decompose a target tracking task into two main steps: target detection and data association. The step of target detection uses various detection algorithms to identify a target in a video frame and outputs information such as a 2D detection box, a classification label, and a confidence degree of the target. The step of data association is used to match a target detection result in a consecutive frame to form a motion trajectory of the target.

Optionally, the image screening module uses a Byte Track algorithm to aggregate the 2D detection boxes of the plurality of candidate objects to form the tracking image sequence corresponding to each candidate object. The ByteTrack algorithm is a commonly used method in the MOT, and the ByteTrack algorithm uses a Kalman filter to predict the trajectory of the target that is detected. By using matching strategies such as a Hungarian algorithm, the predicted trajectory is matched with the target that is detected, so as to update the trajectory state.

The tracking processing module aggregates the 2D detection boxes that are discrete in the time sequence into a continuous tracking image sequence of the different candidate objects, so as to obtain a multi-frame images of the same candidate object from a plurality of perspectives in the collected image sequence, thus more complete observation of the candidate object may be acquired as an input of subsequent modules.
S206: screening the tracking image sequences corresponding to the plurality of candidate objects by the image screening module according to image quality, to obtain a target image sequence corresponding to each candidate object.

The tracking image sequence of a single candidate object is often very long, and using all frames is redundant and inefficient. Therefore, it is required to screen several frames of images in the tracking image sequence of the candidate object, K frames of the images that have the optimal quality are screened to form the target image sequence, and the target image sequence is sent to the downstream for processing, which is helpful to improve the filtering accuracy of the subsequent object filtering module.

The target image sequence corresponding to the candidate object includes K frames of target images, and 2D segmentation masks of the K frames of the target images in the target image sequence form the 2D segmentation mask of the candidate object. K is greater than or equal to 2, and the value of K may be flexibly set according to actual needs.

Exemplarily, the image screening module is specifically used to: for the tracking image sequence corresponding to each candidate object, screen the tracking image sequence corresponding to the candidate object according to a quality parameter of the candidate object, to obtain the target image sequence corresponding to the candidate object, herein the quality parameter includes at least one of the group consisting of: a position of the candidate object in a tracking image, a proportion of an area of the candidate object in the tracking image, or a camera angle corresponding to the candidate object.

The position of the candidate object in the tracking image is the position of the 2D detection box of the candidate object in the tracking image, the proportion of the area of the candidate object in the tracking image may be the ratio of the size of the 2D detection box of the candidate object to the size of the tracking image, and the camera angle corresponding to the candidate object refers to the shooting angle of the tracking image in which the candidate object is located. In the present embodiment, the terminal device may acquire the camera angle of each frame of the image according to the image sequence.

The image screening module may, from the tracking image sequence, select a tracking image in which the position of the candidate object is near the center area of the tracking image as the target image. The position of the candidate object near the edge of the tracking image may be obstructed, which may affect the processing result of the downstream module. Alternatively, a tracking image, in which the proportion of the area of the candidate object is greater than a certain threshold, is selected from the tracking image sequence as the target image. In response to the proportion of the area of the candidate object being too small, it is indicated that the candidate object is very small in the image, and the processing result of the downstream module may also be affected. Alternatively, a tracking image, in which the camera angle is facing the candidate object or which has a relatively small angular offset with the candidate object, is selected from the tracking image sequence as the target image. In response to the angular offset between the camera angle and the candidate object is relatively large, the captured shape of the candidate object may be changed, which may affect the processing result of the downstream module.

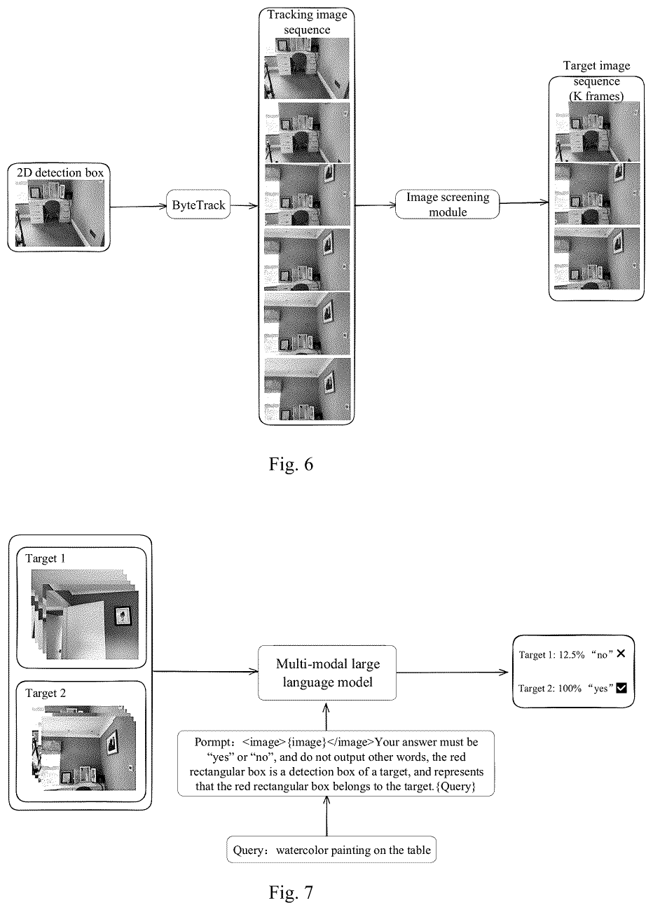

FIG. 6 is a schematic diagram of processing results of a tracking processing module and an image screening module. As shown in FIG. 6, the tracking processing module processes a 2D detection box of a candidate object according to the time sequence, to obtain the tracking image sequence corresponding to the candidate object. The tracking image sequence includes 6 frames of tracking images. The image screening module screens the tracking image sequence corresponding to the candidate object, to obtain the target image sequence corresponding to the candidate object, and the target image sequence corresponding to the candidate object includes 3 frames of target images.

Referring to FIG. 5, after the Grounding-DINO model is used for detection, the ByteTrack algorithm is used to perform tracking processing on each target, to obtain the tracking image sequence corresponding to each candidate object. Then, the tracking image sequence corresponding to each candidate object is screened by the image screening module, to obtain the target image sequence corresponding to each candidate object. The target image sequence is used as the input of the next module.
S207: according to the text description information and the 2D segmentation mask of the target image in the target image sequence corresponding to each candidate object, determining the target object from the plurality of candidate objects by the object filtering module.

In an optional implementation mode, the object filtering module uses a Multimodal Large Language Model (MLLM) to implement a filtering function. The MLLM is an artificial intelligence system that combines a plurality of sense inputs such as visual sense, hearing sense, and text, and the MLLM aims to simulate the mode of which humans process information and provide more comprehensive and accurate language output by integrating multi-modal data. In the present embodiment, any existing MLLM, for example, InternVL, may be used.

The object filtering module is specifically used to: generate a prompt of a multi-modal large language model according to the text description information; determine the prompt and the 2D segmentation mask of the target image in the target image sequence corresponding to each candidate object as inputs of the multi-modal large language model, where the multi-modal large language model is used to identify whether the 2D segmentation mask of the target image is the target object according to the text description information and the 2D segmentation mask of the target image in the target image sequence corresponding to each candidate object, determine a truth proportion of each candidate object according to an identification result, determine whether the candidate object is the target object according to the truth proportion of each candidate object, and output a determination result, and the truth proportion is a ratio of a quantity of images of which the identification results of the candidate objects are true to a total quantity of images in the target image sequence corresponding to the candidate objects; and determine the target object from the plurality of candidate objects according to the identification results of the plurality of candidate objects.

In the implementation mode, a voting mechanism is introduced, and the multi-modal large language model may not only identify whether the candidate object in each frame of the target image is the target object based on the text description information and an image, but also output the truth proportion of each candidate object. The truth proportion is the ratio of the quantity of images of which the identification results of the candidate objects are true to the total quantity of images in the target image sequence corresponding to the candidate objects. For example, when the target image sequence of the candidate object 1 includes 5 frames of images, in response to the identification results of 4 frames of the images being true (i.e., the candidate object in the image is the target object), then the truth proportion of the candidate object is 4/5=80%. In response to the identification result of only 1 frame of the image being true, then the truth proportion of the candidate object is 20%.

FIG. 7 is a schematic diagram of the input and output of a multi-modal large language model. As shown in FIG. 7, the prompt of the multi-modal large language model is: <image> {image}</image>Your answer must be “yes” or “no”, and do not output other words, the red rectangular box is a detection box of a target, and represents that the red rectangular box belongs to the target. {Query}. The “Query” represents the text description information of the target object, and the prompt of the multi-modal large language model has two inputs: query and images of targets. There are two targets in the image (i.e., two candidate objects): target 1 and target 2. The target image sequence of the target 1 and the target image sequence of the target 2 both include a plurality of target images. The output result of the target 1 is “no”, and the output result of the target 2 is “yes”. The truth proportion of the target 1 is 12.5%, and the truth proportion of the target 2 is 100%. Therefore, the output result of the target 2 is “yes”, which represents that the target 2 is the target object, and thus the target 2 of which the output is “yes” is determined as the target object.

In the present embodiment, according to the truth proportion of each candidate object, the multi-modal large language model determines a candidate object of which the truth proportion is greater than a certain threshold as the target object. The threshold is, for example, 85%. When the truth proportion of a certain candidate object is greater than 85%, the candidate object is determined as the target object, and the identification result of the candidate object is output as “yes”.

In another optional implementation mode, the object filtering module uses a VLM, and the VLM is a multi-modal model. In the present embodiment, the input of the VLM is the text description information and the 2D segmentation mask of the target image in the target image sequence corresponding to each candidate object. The VLM is used to identify whether the 2D segmentation mask of the target image is the target object according to the text description information and the 2D segmentation mask of the target image in the target image sequence corresponding to each candidate object; and determine the target object from the plurality of candidate objects according to an identification result of each candidate object.

The VLM may compute the similarity between the 2D segmentation mask in the target image and the text description information, and determine whether the candidate object in the target image is the target object according to the similarity. When the similarity is greater than a preset similarity threshold, the VLM determines that the candidate object in the target image is the target object, and when the similarity is less than or equal to the preset similarity threshold, the VLM determines that the candidate object in the target image is not the target object. According to the identification result of each candidate object, the truth proportion corresponding to each candidate object may be determined, and according to the truth proportions of the plurality of candidate objects, one object is selected as the target object.

The multi-modal large language model and the VLM are both multi-modal models, and include a text modal and an image modal. Using the multi-modal model for object filtering may improve the accuracy of the filtering result, thereby the accuracy of the final retrieval result is improved.
S208: projecting a 2D segmentation mask of the target object into a 3D scene by the 3D projection module according to image depth information, and correcting a projection result to obtain a position of the target object in the 3D scene.

When the 2D segmentation mask of the target object includes the 2D segmentation masks of a multi-frame target images, the 3D projection module merges and projects the 2D segmentation masks of the multi-frame target images into the 3D scene according to the depth information of the multi-frame target images, to obtain a first 3D segmentation mask of the target object.

When the terminal device acquires the image sequence of the real scene, the terminal device may also acquire the depth information of each frame of the image, and the terminal device may acquire the depth information of each frame of the image by a depth camera. For each frame of the target image, the 3D projection module obtains three-dimensional coordinates of each pixel in the 2D segmentation mask in the 3D scene according to the depth information of the target image and the 2D segmentation mask. The 3D scene is the real scene, and the pixel points of all the 2D segmentation mask of the target object are projected into the 3D scene to obtain 3D points, which form the first 3D segmentation mask.

A point cloud formed by all points of the first 3D segmentation mask is usually sparse, and is known as a sparse point cloud of the first 3D segmentation mask. The 3D projection module firstly performs point cloud extension on a sparse point cloud of the first 3D segmentation mask to obtain a complete and dense second 3D segmentation mask. The second 3D segmentation mask is corrected by using the following correction strategies:
(1) re-projecting the second 3D segmentation mask into each frame of the target image, to obtain a first 2D segmentation mask of the target object in each frame of the target image; and for each frame of the target image, according to a position of the 2D segmentation mask of the target image, filtering out a projection point outside the 2D segmentation mask of the target image from the first 2D segmentation mask, to obtain a second 2D segmentation mask of the target object.

(2) merging and projecting the second 2D segmentation masks in the multi-frame target images into the 3D scene to obtain a third 3D segmentation mask according to the depth information of the multi-frame target images; and determining the position of the target object in the 3D scene according to the third 3D segmentation mask.

Exemplarily, the 3D projection module may use a k-Nearest Neighbor (KNN) algorithm to perform neighbor point cloud extension on the sparse point cloud of the first 3D segmentation mask, and the complete and dense second 3D segmentation mask is obtained by the neighbor point cloud extension.

When the point cloud extension is performed on the sparse point cloud of the first 3D segmentation mask, some non-target points may be introduced. In order to filter out the non-target points introduced by the point cloud extension, the 3D projection module re-projects the second 3D segmentation mask back into a 2D space.

Re-projection refers to projecting 3D points in the 3D scene onto a 2D image (i.e., a 2D space). When the second 3D segmentation mask is re-projected back into the 2D space, the second 3D segmentation mask needs to be re-projected onto each frame of the target image. The 3D projection module needs to acquire camera pose and camera intrinsic parameters of each frame of the target image. According to the camera pose and the camera intrinsic parameters of each frame of the target image, each 3D point in the second 3D segmentation mask is re-projected into the target image, the first 2D segmentation mask of the target object in each frame of the target image is obtained, and the first 2D segmentation mask is the 2D segmentation mask obtained by re-projection.

The pixel points in the 2D segmentation mask obtained by re-projection are also called projection points. A part of the projection points in the first 2D segmentation mask of each frame of the target image may be located outside the 2D segmentation mask region of the target image. For each frame of the target image, according to the position of the 2D segmentation mask of the target image, the projection points outside the 2D segmentation mask of the target image are filtered out from all the projection points included in the first 2D segmentation mask, and only the projection points in the first 2D segmentation mask that are located inside the 2D segmentation mask of the target image are retained, and the second 2D segmentation mask of the target object is obtained.

Finally, according to the depth information of the multi-frame target images, the second 2D segmentation masks in the multi-frame target images are merged and projected into the 3D scene to obtain the third 3D segmentation mask, and the position of the target object in the 3D scene is determined according to the third 3D segmentation mask.

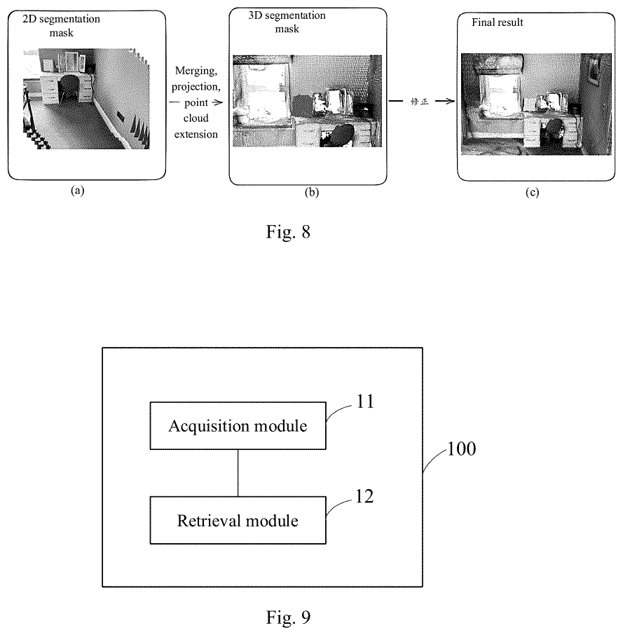

FIG. 8 is a schematic diagram of data changes during the projection and correction process of a 3D projection module. As shown in FIG. 8, the 3D projection module firstly merges and projects the 2D segmentation masks (i.e., as shown in FIG. 8 (a)) in the multi-frame target images, and performs the point cloud extension to obtain the complete and dense second 3D segmentation mask shown in FIG. 8 (b). Finally, the second 3D segmentation mask is corrected to obtain the final 3D segmentation mask, as shown in FIG. 8 (c).

In an optional implementation mode, the pixel points in the third 3D segmentation mask are directly used as pixel points of the target object to obtain the 3D position of the target object in the 3D scene.

In another optional implementation mode, noise points in the third 3D segmentation mask are filtered out to obtain a fourth 3D segmentation mask, and the position of the target object in the 3D scene is determined according to the fourth 3D segmentation mask.

Usually, the third 3D segmentation mask may include the noise points. By filtering out the noise points in the third 3D segmentation mask, the accuracy of the retrieval result of the open-vocabulary 3D target is improved.

Optionally, a connected region is determined according to points in the third 3D segmentation mask, and isolated noise points in the third 3D segmentation mask are filtered out according to a size of the connected region to obtain the fourth 3D segmentation mask. The isolated noise points refer to points located outside the connected region, and these points are usually not connected to other points and are therefore called the isolated noise points.

Optionally, the 2D segmentation mask of the target object may also only include the 2D segmentation mask of one frame of the target image. Correspondingly, the 3D projection module is specifically used to project the 2D segmentation mask of the frame of the target image into the 3D scene according to the depth information of the frame of the target image, to obtain the first 3D segmentation mask of the target object. Different from the situation of the 2D segmentation masks of multi-frame target images, when there is the 2D segmentation mask of only one frame of the target image, there is no need to merge and project, the 2D segmentation mask of the single frame of the target image only needs to be projected into the 3D scene. The correction method after the projection is the same as that for the multi-frame target images, and it is not repeatedly described here.

In the present embodiment, the open-vocabulary 3D target retrieval model is used for open-vocabulary 3D target retrieval. The open-vocabulary 3D target retrieval model includes an LLM, an open-vocabulary 2D detection and segmentation model, a tracking processing module, an image screening module, an object filtering module, and a 3D projection module. The object filtering module may use a multi-modal model, and the retrieval of the open-vocabulary 3D target is implemented by pipeline processing of a plurality of pre-trained models mentioned above, which improves the accuracy and recall rate of open-vocabulary 3D target retrieval results in the real scene.

The retrieval method for the open-vocabulary 3D target provided in the embodiments of the present disclosure may be applied in the field of MR. When a user uses an MR application on an XR device for gaming or other tasks, the user may wear a head-mounted device and move in a room (i.e., the real scene). A camera of the head-mounted device collects room images, and uses a Video Pass-Through (VST) function to display the room on a displayer, and the room images may also be used for open-vocabulary 3D target retrieval to perceive and understand objects in the room in order to interact with real objects.

The retrieval model for the open-vocabulary 3D target may detect novel or non-existent 3D objects. When a new object appears in the room, the retrieval model for the open-vocabulary 3D target may also retrieval that object. In addition, the retrieval model for the open-vocabulary 3D target has the better adaptability, and it may be applied to different 3D scenes and has the good performance.

In order to facilitate the better implementation of the retrieval method for the open-vocabulary 3D target of the embodiments of the present disclosure, the embodiments of the disclosure further provide a retrieval apparatus for the open-vocabulary 3D target. FIG. 9 is a structural schematic diagram of a retrieval apparatus for an open-vocabulary 3D target provided in an embodiment of the present disclosure. As shown in FIG. 9, the retrieval apparatus 100 for an open-vocabulary 3D target may include an acquisition module 11 and a retrieval module 12.

The acquisition module 11 is configured to acquire text description information of a target object and an image sequence of a real scene.

The retrieval module 12 is configured to input the text description information and the image sequence into an open-vocabulary dimensional (3D) target retrieval model, to obtain a retrieval result of the target object. The open-vocabulary 3D target retrieval model includes a large language model (LLM), an open-vocabulary two-dimensional (2D) detection and segmentation model, an object filtering module and a 3D projection module.

The LLM is used to enhance the text description information, to obtain names of a plurality of candidate objects of the target object.

The open-vocabulary 2D detection and segmentation model is used to detect and segment the plurality of candidate objects by using the names of the plurality of candidate objects and the image sequence as inputs, to obtain 2D segmentation masks of the plurality of candidate objects.

The object filtering module is used to determine the target object from the plurality of candidate objects according to the text description information and the 2D segmentation mask of each candidate object.

The 3D projection module is used to project a 2D segmentation mask of the target object into a 3D scene according to image depth information, and correct a projection result to obtain a position of the target object in the 3D scene.

In some exemplary embodiments, the open-vocabulary 3D target retrieval model further includes a tracking processing module and an image screening module, and a detection result of the open-vocabulary 2D detection and segmentation model further includes 2D detection boxes of the plurality of candidate objects.

The tracking processing module is used to, according to temporal information of the 2D detection boxes of the plurality of candidate objects, perform tracking processing on the plurality of candidate objects to form a tracking image sequence corresponding to each candidate object.

The image screening module is used to screen the tracking image sequences corresponding to the plurality of candidate objects according to image quality, to obtain a target image sequence corresponding to each candidate object, a 2D segmentation mask of a target image in the target image sequence corresponding to the candidate object forms the 2D segmentation mask of the candidate object.

The object filtering module is specifically used to determine the target object from the plurality of candidate objects according to the text description information and the 2D segmentation mask of the target image in the target image sequence corresponding to each candidate object.

In some exemplary embodiments, the tracking processing module uses a ByteTrack algorithm to aggregate the 2D detection boxes of the plurality of candidate objects to form a tracking image sequence corresponding to each candidate object.

In some exemplary embodiments, the image screening module is specifically used to: for the tracking image sequence corresponding to each candidate object, screen the tracking image sequence corresponding to the candidate object according to a quality parameter of the candidate object, to obtain the target image sequence corresponding to the candidate object, where the quality parameter includes at least one of the group consisting of: a position of the candidate object in a tracking image, a proportion of an area of the candidate object in the tracking image, or a camera angle corresponding to the candidate object.

In some exemplary embodiments, the object filtering module is specifically used to:
generate a prompt of a multi-modal large language model according to the text description information;
determine the prompt and the 2D segmentation mask of the target image in the target image sequence corresponding to each candidate object as inputs of the multi-modal large language model.

The multi-modal large language model is used to identify whether the 2D segmentation mask of the target image is the target object according to the text description information and the 2D segmentation mask of the target image in the target image sequence corresponding to each candidate object, determine a truth proportion of each candidate object according to an identification result, determine whether the candidate object is the target object according to the truth proportion of each candidate object, and output a determination result, where the truth proportion is a ratio of a quantity of images of which the identification results of the candidate objects are true to a total quantity of images in the target image sequence corresponding to the candidate objects; and according to the identification results of the multiple candidate objects, determine the target object from the plurality of candidate objects.

In some exemplary embodiments, the object filtering module is used to:
use the text description information and the 2D segmentation mask of the target image in the target image sequence corresponding to each candidate object as inputs of a visual language model.

The visual language model is used to: identify whether the 2D segmentation mask of the target image is the target object according to the text description information and the 2D segmentation mask of the target image in the target image sequence corresponding to each candidate object; and determine the target object from the plurality of candidate objects according to an identification result of each candidate object.

In some exemplary embodiments, the 3D projection module is used to:
when the 2D segmentation mask of the target object includes 2D segmentation masks of a multi-frame target images, merge and project the 2D segmentation masks of the multi-frame target images into the 3D scene according to depth information of the multi-frame target images, to obtain a first 3D segmentation mask of the target object;
perform point cloud expansion on a sparse point cloud of the first 3D segmentation mask, to obtain a complete and dense second 3D segmentation mask;
re-project the second 3D segmentation mask into each frame of the target image, to obtain a first 2D segmentation mask of the target object in each frame of the target image;
for each frame of the target image, according to a position of the 2D segmentation mask of the target image, filter out a projection point outside the 2D segmentation mask of the target image from the first 2D segmentation mask, to obtain a second 2D segmentation mask of the target object;
merge and project the second 2D segmentation masks in the multi-frame target images into the 3D scene to obtain a third 3D segmentation mask according to the depth information of the multi-frame target images; and determine the position of the target object in the 3D scene according to the third 3D segmentation

mask.

In some exemplary embodiments, the determining the position of the target object in the 3D scene according to the third 3D segmentation mask, includes:
filtering out noise points in the third 3D segmentation mask to obtain a fourth 3D segmentation mask; and
determining the position of the target object in the 3D scene according to the fourth 3D segmentation mask.

In some exemplary embodiments, the filtering out noise points in the third 3D segmentation mask to obtain a fourth 3D segmentation mask, includes:
determining a connected region according to points in the third 3D segmentation mask, and filtering out isolated noise points in the third 3D segmentation mask according to a size of the connected region to obtain the fourth 3D segmentation mask.

In some exemplary embodiments, the enhancing the text description information to obtain names of a plurality of candidate objects of the target object, includes:
generating a prompt of the LLM according to the text description information; and
inputting the prompt into the LLM, to obtain the names of the plurality of candidate objects of the target object, where the LLM is used to extract a subject name from the text description information, perform synonym and/or near-synonym extension on the extracted subject name to obtain one or more extension names, and determine the subject name and the extension names as the names of the candidate objects of the target object.

In some exemplary embodiments, the open-vocabulary 2D detection and segmentation model uses a grounding-SAM model.

It should be understood that apparatus embodiments and method embodiments can correspond to each other, and similar descriptions may refer to method embodiments and will not be repeated here to avoid repetition.

The apparatus 100 of the embodiments of the present disclosure is described above from the perspective of a functional module in conjunction with the accompanying drawings. It should be understood that the functional module may be implemented in the form of hardware, as well as in the form of instructions in the form of software, and may also be implemented through a combination of hardware and software modules. Specifically, each step of the method embodiments in the embodiments of the present disclosure may be completed by an integrated logic circuit and/or instruction in the form of software of the hardware in the processor, and the steps of the method disclosed in the embodiments of the present disclosure may be directly embodied in the completion of the execution of the hardware decoding processor, or the execution of the combination of the hardware and software modules in the decoding processor. Optionally, the software module may be located in mature storage media such as random memory, flash memory, read-only memory, programmable read-only memory, electrical erasable programmable memory, registers, etc. The storage medium is located in memory, and the processor reads the information in the memory and completes the steps in the above method embodiments in combination with its hardware.

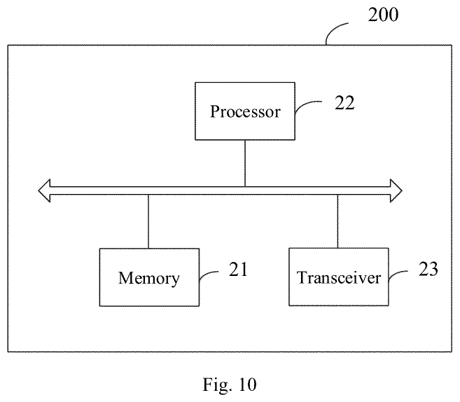

An embodiment of the present disclosure further provides an electronic device. FIG. 10 is a structural schematic diagram of an electronic device provided in an embodiment of the present disclosure. As shown in FIG. 10, the electronic device 200 may include a memory 21 and a processor 22.

The memory 21 is configured to store a computer program and transmit the computer program to the processor 22. In other words, the processor 22 may invoke and run the computer program from the memory 21 to implement the method described in the embodiment of the present disclosure.

For example, the processor 22 may be used to execute the method described in the above method embodiments according to instructions in the computer program.

In some embodiments of the present disclosure, the processor may include, but is not limited to, a general-purpose processor, a digital signal processor (DSP), an Application Specific Integrated Circuit (ASIC), a Field Programmable Gate Array (FPGA) or other programmable logic device, discrete gate or transistor logic device, discrete hardware component, and so on.

In some embodiments of the present disclosure, the memory 21 includes, but is not limited to: volatile memory and/or non-volatile memory. The non-volatile memory may be a read-only memory (ROM), a programmable ROM (PROM), an erasable PROM (EPROM), an electrically erasable programmable read-only memory (EEPROM), or a flash memory. The volatile memory may be a Random Access Memory (RAM), which is used as an external cache. By illustrative but not restrictive illustration, many forms of the RAM are available, such as Static RAM (SRAM), Dynamic RAM (DRAM), Synchronous DRAM (SDRAM), Double Data Rate SDRAM (DDR SDRAM), Enhanced Dynamic Random Access Memory (ESDRAM), synch link DRAM (SLDRAM), and Direct Rambus RAM (DR RAM).

In some embodiments of the present disclosure, the computer program may be divided into one or more modules, and the one or more modules are stored in the memory 21 and executed by the processor 22 to complete the method provided in the present disclosure. The one or more modules may be a series of computer program instruction segments capable of performing a specific function, which describes the execution of the computer program in an electronic device.

As shown in FIG. 10, the electronic device may further include a transceiver 23 and a display screen (not shown in FIG. 10) etc. The transceiver 23 may be connected to the processor 22 or the memory 21, and the display may be connected to the processor 22 or the memory 21.

The processor 22 may control the transceiver 23 to communicate with other devices, specifically, to send information or data to other devices, or to receive information or data sent by other devices. The transceiver 23 may include a transmitter and a receiver. The transceiver 23 may further include an antenna, and the number of antennas may be one or more.

The display screen may be used to display the graphical user interface and receive the user's operating instructions acting on the graphical user interface. The display screen may be a touch display screen, and the touch display screen may include a display panel and a touch panel. The display panel may be used to display the information entered by the user or provided to the user and various graphical user interfaces of the computer device. The graphical user interfaces may be composed of graphics, text, icons, videos and any combination thereof. Optionally, the display panel may be configured in the form of liquid crystal display (LCD), organic light-emitting diode (OLED), etc. The touch panel may be used to collect the user's touch actions on or near it (such as the user's actions on or near the touch panel with any suitable object or accessory such as fingers, stylus, etc.), and generate corresponding operation instructions, and the operation instructions execute the corresponding program. Optionally, the touch panel may include two parts: a touch detection apparatus and a touch controller. The touch detection apparatus detects the user's touch orientation, detects the signal brought by the touch operation, and transmits the signal to the touch controller. The touch controller receives the touch information from the touch detection apparatus, converts the touch information into contact coordinates, sends the contact coordinates to the processor 32 again, and may receive a command sent by the processor 32 and executes the command. The touch panel may cover the display panel, and when the touch panel detects a touch operation on or near the touch panel, the touch operation is transmitted to the processor 32 to determine the type of touch event, and then the processor 32 provides a corresponding visual output on the display panel according to the type of touch event.

It is understandable that, although not shown in FIG. 10, the electronic device 200 may further include a camera module, a wireless fidelity WIFI module, a positioning module, a Bluetooth module, an audio module, etc., which will not be repeated herein.

It should be understood that the various components in the electronic device are connected by a bus system. The bus system includes a power bus, a control bus and a status signal bus in addition to the data bus.

The present disclosure further provides a computer storage medium, on which a computer program is stored. When the computer program is executed by a computer, the computer is caused to execute the method of the above method embodiments. In other words, the embodiments of the present disclosure further provides a computer program product that includes an instruction. when the instruction is executed by a computer, the computer is caused to execute the method of the above method embodiments.

The present disclosure further provides a computer program product. The computer program product includes a computer program. The computer program is stored in a computer-readable storage medium. The processor of an electronic device reads the computer program from the computer-readable storage medium, and the processor executes the computer program to cause the electronic device to execute the method steps described in the method embodiments of the present disclosure. For the sake of brevity, it will not be repeated here.

In some embodiments provided in the present disclosure, it should be understood that the disclosed systems, apparatuses and methods may be implemented by other means. For example, the apparatus embodiments described above is only schematic, for example, the division of the modules is only a logical function division, and there may be another division in the actual implementation, such as a plurality of modules or components may be combined or integrated into another system, or some features may be ignored or not executed. On the other hand, the coupling or direct coupling or communication connection between each other shown or discussed may be indirect coupling or communication connection through some interfaces, apparatuses or modules, which may be in electrical, mechanical or other form.

As a separate part description of the module may be or may not be physically separated, as a module display of the part may or may not be a physical module, that is, may be located in one place, or may also be distributed to a plurality of network elements. Some or all of the modules may be selected according to actual needs to implement the purpose of the present embodiments. For example, each functional module in each embodiment of the present disclosure may be integrated in a processing module, or each module may physically exist separately, or two or more modules may be integrated in a module.

The above is only the specific embodiment of the present disclosure, but the scope of protection of the present disclosure is not limited to it. In the scope of the technology disclosed in the present disclosure, any change or replacement that can be easily thought of by a skilled person familiar with the technical field should be covered within the scope of protection of the present disclosure. Therefore, the scope of protection of the present disclosure shall be subject to the scope of protection of the claims.

1. A retrieval method for an open-vocabulary three-dimensional (3D) target, comprising:
acquiring text description information of a target object and an image sequence of a real scene; and
inputting the text description information and the image sequence into an open-vocabulary 3D target retrieval model, to obtain a retrieval result of the target object, wherein the open-vocabulary 3D target retrieval model comprises a large language model (LLM), an open-vocabulary two-dimensional (2D) detection and segmentation model, an object filtering module and a 3D projection module;
wherein the LLM is used to enhance the text description information to obtain names of a plurality of candidate objects of the target object;
the open-vocabulary 2D detection and segmentation model is used to detect and segment the plurality of candidate objects by using the names of the plurality of candidate objects and the image sequence as inputs, to obtain 2D segmentation masks of the plurality of candidate objects;
the object filtering module is used to determine the target object from the plurality of candidate objects according to the text description information and a 2D segmentation mask of each candidate object; and
the 3D projection module is used to project a 2D segmentation mask of the target object into a 3D scene according to image depth information, and correct a projection result to obtain a position of the target object in the 3D scene.

2. The method according to claim 1, wherein the open-vocabulary 3D target retrieval model further comprises a tracking processing module and an image screening module, and a detection result of the open-vocabulary 2D detection and segmentation model further comprises 2D detection boxes of the plurality of candidate objects;
the tracking processing module is used to, according to temporal information of the 2D detection boxes of the plurality of candidate objects, perform tracking processing on the plurality of candidate objects to form a tracking image sequence corresponding to each candidate object;
the image screening module is used to screen the tracking image sequences corresponding to the plurality of candidate objects according to image quality, to obtain a target image sequence corresponding to each candidate object, a 2D segmentation mask of a target image in the target image sequence corresponding to the candidate object forms the 2D segmentation mask of the candidate object; and
the object filtering module is used to determine the target object from the plurality of candidate objects according to the text description information and the 2D segmentation mask of the target image in the target image sequence corresponding to each candidate object.

3. The method according to claim 2, wherein the tracking processing module uses a ByteTrack algorithm to aggregate the 2D detection boxes of the plurality of candidate objects to form a tracking image sequence corresponding to each candidate object.

4. The method according to claim 2, wherein the image screening module is used to: for the tracking image sequence corresponding to each candidate object, screen the tracking image sequence corresponding to the candidate object according to a quality parameter of the candidate object, to obtain the target image sequence corresponding to the candidate object, and the quality parameter comprises at least one of the group consisting of: a position of the candidate object in a tracking image, a proportion of an area of the candidate object in the tracking image, or a camera angle corresponding to the candidate object.

5. The method according to claim 2, wherein the object filtering module is used to:
generate a prompt of a multi-modal large language model according to the text description information;
determine the prompt and the 2D segmentation mask of the target image in the target image sequence corresponding to each candidate object as inputs of the multi-modal large language model;
wherein the multi-modal large language model is used to identify whether the 2D segmentation mask of the target image is the target object according to the text description information and the 2D segmentation mask of the target image in the target image sequence corresponding to each candidate object, determine a truth proportion of each candidate object according to an identification result, determine whether the candidate object is the target object according to the truth proportion of each candidate object, and output a determination result, wherein the truth proportion is a ratio of a quantity of images of which the identification results of the candidate objects are true to a total quantity of images in the target image sequence corresponding to the candidate objects; and
according to the identification results of the multiple candidate objects, determine the target object from the plurality of candidate objects.

6. The method according to claim 2, wherein the object filtering module is used to:
use the text description information and the 2D segmentation mask of the target image in the target image sequence corresponding to each candidate object as inputs of a visual language model; and
the visual language model is used to identify whether the 2D segmentation mask of the target image is the target object according to the text description information and the 2D segmentation mask of the target image in the target image sequence corresponding to each candidate object; and determine the target object from the plurality of candidate objects according to an identification result of each candidate object.

7. The method according to claim 1, wherein the 3D projection module is used to:
when the 2D segmentation mask of the target object comprises 2D segmentation masks of multi-frame target images, merge and project the 2D segmentation masks of the multi-frame target images into the 3D scene according to depth information of the multi-frame target images, to obtain a first 3D segmentation mask of the target object;
perform point cloud expansion on a sparse point cloud of the first 3D segmentation mask, to obtain a complete and dense second 3D segmentation mask;
re-project the second 3D segmentation mask into each frame of the target image, to obtain a first 2D segmentation mask of the target object in each frame of the target image;
for each frame of the target image, according to a position of the 2D segmentation mask of the target image, filter out a projection point outside the 2D segmentation mask of the target image from the first 2D segmentation mask, to obtain a second 2D segmentation mask of the target object;
merge and project the second 2D segmentation masks in multi-frame target images into the 3D scene to obtain a third 3D segmentation mask according to the depth information of the multi-frame target images; and
determine the position of the target object in the 3D scene according to the third 3D segmentation mask.

8. The method according to claim 7, wherein the determining the position of the target object in the 3D scene according to the third 3D segmentation mask, comprises:
filtering out noise points in the third 3D segmentation mask to obtain a fourth 3D segmentation mask; and
determining the position of the target object in the 3D scene according to the fourth 3D segmentation mask.

9. The method according to claim 8, wherein the filtering out noise points in the third 3D segmentation mask to obtain a fourth 3D segmentation mask, comprises:
determining a connected region according to points in the third 3D segmentation mask, and filtering out isolated noise points in the third 3D segmentation mask according to a size of the connected region to obtain the fourth 3D segmentation mask.

10. The method according to claim 1, wherein the enhancing the text description information, to obtain names of a plurality of candidate objects of the target object, comprising:
generating a prompt of the LLM according to the text description information; and
inputting the prompt into the LLM, to obtain the names of the plurality of candidate objects of the target object, wherein the LLM is used to extract a subject name from the text description information, perform synonym and/or near-synonym extension on the extracted subject name to obtain one or more extension names, and determine the subject name and the extension names as the names of the candidate objects of the target object.

11. The method according to claim 1, wherein the open-vocabulary 2D detection and segmentation model uses a grounding-SAM model.

12. An electronic device, comprising:
at least one processor and at least one memory, wherein the at least one memory is configured to store a computer program, the at least one processor is configured to invoke and run the computer program stored in the at least one memory, to execute a retrieval method for an open-vocabulary three-dimensional (3D) target, and the method comprises:
acquiring text description information of a target object and an image sequence of a real scene; and
inputting the text description information and the image sequence into an open-vocabulary 3D target retrieval model, to obtain a retrieval result of the target object, wherein the open-vocabulary 3D target retrieval model comprises a large language model (LLM), an open-vocabulary two-dimensional (2D) detection and segmentation model, an object filtering module and a 3D projection module;
wherein the LLM is used to enhance the text description information to obtain names of a plurality of candidate objects of the target object;
the open-vocabulary 2D detection and segmentation model is used to detect and segment the plurality of candidate objects by using the names of the plurality of candidate objects and the image sequence as inputs, to obtain 2D segmentation masks of the plurality of candidate objects;
the object filtering module is used to determine the target object from the plurality of candidate objects according to the text description information and a 2D segmentation mask of each candidate object; and
the 3D projection module is used to project a 2D segmentation mask of the target object into a 3D scene according to image depth information, and correct a projection result to obtain a position of the target object in the 3D scene.

13. A non-transitory computer-readable storage medium, wherein the non-transitory computer-readable storage medium is configured to store a computer program, the computer program causes a computer to execute a retrieval method for an open-vocabulary three-dimensional (3D) target, and the method comprises:
acquiring text description information of a target object and an image sequence of a real scene; and
inputting the text description information and the image sequence into an open-vocabulary 3D target retrieval model, to obtain a retrieval result of the target object, wherein the open-vocabulary 3D target retrieval model comprises a large language model (LLM), an open-vocabulary two-dimensional (2D) detection and segmentation model, an object filtering module and a 3D projection module;
wherein the LLM is used to enhance the text description information to obtain names of a plurality of candidate objects of the target object;
the open-vocabulary 2D detection and segmentation model is used to detect and segment the plurality of candidate objects by using the names of the plurality of candidate objects and the image sequence as inputs, to obtain 2D segmentation masks of the plurality of candidate objects;
the object filtering module is used to determine the target object from the plurality of candidate objects according to the text description information and a 2D segmentation mask of each candidate object; and
the 3D projection module is used to project a 2D segmentation mask of the target object into a 3D scene according to image depth information, and correct a projection result to obtain a position of the target object in the 3D scene.

14. The non-transitory computer-readable storage medium according to claim 13, wherein the open-vocabulary 3D target retrieval model further comprises a tracking processing module and an image screening module, and a detection result of the open-vocabulary 2D detection and segmentation model further comprises 2D detection boxes of the plurality of candidate objects;
the tracking processing module is used to, according to temporal information of the 2D detection boxes of the plurality of candidate objects, perform tracking processing on the plurality of candidate objects to form a tracking image sequence corresponding to each candidate object;
the image screening module is used to screen the tracking image sequences corresponding to the plurality of candidate objects according to image quality, to obtain a target image sequence corresponding to each candidate object, a 2D segmentation mask of a target image in the target image sequence corresponding to the candidate object forms the 2D segmentation mask of the candidate object; and
the object filtering module is used to determine the target object from the plurality of candidate objects according to the text description information and the 2D segmentation mask of the target image in the target image sequence corresponding to each candidate object.

15. The non-transitory computer-readable storage medium according to claim 14, wherein the tracking processing module uses a ByteTrack algorithm to aggregate the 2D detection boxes of the plurality of candidate objects to form a tracking image sequence corresponding to each candidate object.

16. The non-transitory computer-readable storage medium according to claim 14, wherein the image screening module is used to: for the tracking image sequence corresponding to each candidate object, screen the tracking image sequence corresponding to the candidate object according to a quality parameter of the candidate object, to obtain the target image sequence corresponding to the candidate object, and the quality parameter comprises at least one of the group consisting of: a position of the candidate object in a tracking image, a proportion of an area of the candidate object in the tracking image, or a camera angle corresponding to the candidate object.

17. The non-transitory computer-readable storage medium according to claim 14, wherein the object filtering module is used to:
generate a prompt of a multi-modal large language model according to the text description information;
determine the prompt and the 2D segmentation mask of the target image in the target image sequence corresponding to each candidate object as inputs of the multi-modal large language model;
wherein the multi-modal large language model is used to identify whether the 2D segmentation mask of the target image is the target object according to the text description information and the 2D segmentation mask of the target image in the target image sequence corresponding to each candidate object, determine a truth proportion of each candidate object according to an identification result, determine whether the candidate object is the target object according to the truth proportion of each candidate object, and output a determination result, wherein the truth proportion is a ratio of a quantity of images of which the identification results of the candidate objects are true to a total quantity of images in the target image sequence corresponding to the candidate objects; and
according to the identification results of the multiple candidate objects, determine the target object from the plurality of candidate objects.

18. The non-transitory computer-readable storage medium according to claim 14, wherein the object filtering module is used to:
use the text description information and the 2D segmentation mask of the target image in the target image sequence corresponding to each candidate object as inputs of a visual language model; and
the visual language model is used to identify whether the 2D segmentation mask of the target image is the target object according to the text description information and the 2D segmentation mask of the target image in the target image sequence corresponding to each candidate object; and determine the target object from the plurality of candidate objects according to an identification result of each candidate object.

19. The non-transitory computer-readable storage medium according to claim 13, wherein the 3D projection module is used to:
when the 2D segmentation mask of the target object comprises 2D segmentation masks of multi-frame target images, merge and project the 2D segmentation masks of the multi-frame target images into the 3D scene according to depth information of the multi-frame target images, to obtain a first 3D segmentation mask of the target object;
perform point cloud expansion on a sparse point cloud of the first 3D segmentation mask, to obtain a complete and dense second 3D segmentation mask;
re-project the second 3D segmentation mask into each frame of the target image, to obtain a first 2D segmentation mask of the target object in each frame of the target image;
for each frame of the target image, according to a position of the 2D segmentation mask of the target image, filter out a projection point outside the 2D segmentation mask of the target image from the first 2D segmentation mask, to obtain a second 2D segmentation mask of the target object;
merge and project the second 2D segmentation masks in multi-frame target images into the 3D scene to obtain a third 3D segmentation mask according to the depth information of the multi-frame target images; and
determine the position of the target object in the 3D scene according to the third 3D segmentation mask.

20. The non-transitory computer-readable storage medium according to claim 19, wherein the determining the position of the target object in the 3D scene according to the third 3D segmentation mask, comprises:
filtering out noise points in the third 3D segmentation mask to obtain a fourth 3D segmentation mask; and
determining the position of the target object in the 3D scene according to the fourth 3D segmentation mask.
